(19) United States
(12) Patent Application Publication
(10) Pub. No.: US 2025/0124623 A1
(43) Pub. Date: Apr. 17, 2025

(54) GENERATING EDITABLE TEMPLATES FOR DESIGNS

(71) Applicant: Microsoft Technology Licensing, LLC, Redmond, WA (US)

(72) Inventors: Mingxi CHENG, Los Angeles, CA (US); Ji LI, San Jose, CA (US); Sumithra BHAKTHAVATSALAM, Kirkland, WA (US)

(73) Assignee: Microsoft Technology Licensing, LLC, Redmond, WA (US)

(21) Appl. No.: 18/485,358

(22) Filed: Oct. 12, 2023

(51) Int. Cl. G06T 11/60; G06F 40/40; G06T 5/00; G06V 30/148; G06V 30/19

(52) U.S. Cl. CPC G06T 11/60; G06F 40/40; G06T 5/77; G06V 30/153; G06V 30/19

(57) ABSTRACT

A data processing system includes a processor, and a memory storing executable instructions which, when executed by the processor, cause the processor alone or in combination with other processors to perform the following functions: based on a list of design purposes, generate prompts requesting a Large Language Model (LLM) to produce corresponding prompts for input to a text-to-image model to generate a proposed design corresponding to each design purpose; submit the prompts from the LLM to the text-to-image model; receive the proposed designs from the text-to-image model; and increase a design template library by adding a design based on the proposed designs output by the text-to-image model.

### BACKGROUND

Design applications allow users to create visually appealing and professionally crafted digital content across various platforms. These applications offer a wide range of features and tools that cater to both beginners and experienced designers. Users can work with various media types, including text, images, and graphics, to produce eye-catching designs.

Some such design and other productivity applications include a feature that proposes a design for a work that a user wants to create. For example, a presentation or slide deck application may take elements a user is adding to a slide and propose an overall design for the slide using those elements. In other cases, the user may search for a design template based on the type of work being prepared. In either case, the user is then able to edit the suggested design to make adjustments based on their preferences or to add personalized content.

These design suggestion features typically make use of a library of templates and design assets. Users can choose from a diverse collection of templates for different purposes, from social media graphics to business presentations. This library may include a smaller number of distinct templates, with each distinct template being supplemented by a number of variations on that design. These variants may change the size, color, or other parameters of the elements in the parent design.

The application selects a template or several templates and, if available, fits user elements to each template. In either case, the user is then presented with the proposed design or design options. The user can select a preferred design and make further adjustments as preferred.

Consequently, the ability of such design features to satisfy the preferences of a user is limited by the number of available templates. The more templates, particularly distinct templates, available, the more likely it is that the tool can present a design that fully satisfies the user. Thus, a technical problem in this field is the limited size of a template library from which to present proposed designs to the user.

### SUMMARY

In one general aspect, the instant disclosure presents a data processing system that includes a processor, and a memory storing executable instructions which, when executed by the processor, cause the processor alone or in combination with other processors to perform the following functions: based on a list of design purposes, generate prompts requesting a Large Language Model (LLM) to produce corresponding prompts for input to a text-to-image model to generate a proposed design corresponding to each design purpose; submit the prompts from the LLM to the text-to-image model; receive the proposed designs from the text-to-image model; and increase a design template library by adding a design based on the proposed designs output by the text-to-image model.

In another aspect, the following description provides a method of increasing a design template library supporting a design recommendation feature in a productivity application, the method including, based on a list of design purposes, generating prompts requesting a Large Language Model (LLM) to produce corresponding prompts for a text-to-image model for the text-to-image model to generate a proposed design corresponding to each design purpose; receiving the proposed design from the text-to-image model; and increasing a design template library by adding a design based on the proposed design output by the text-to-image model.

In another aspect, the following description provides a method of increasing a design template library supporting a design recommendation feature in a productivity application, the method including: based on a list of design purposes, generating prompts requesting a Large Language Model (LLM) to produce corresponding prompts for a text-to-image model for the text-to-image model to generate a proposed design corresponding to each design purpose; receiving the proposed design from the text-to-image model; removing text generated by the text-to-image model from within the proposed design by using an Optical Character Recognition (OCR) tool to identify the text in the proposed design, using a Segment Anything Model (SAM) to identify a text mask for the text used to remove the text; and using an inpainting tool to fill in the proposed design where the text was removed; and providing a resulting design based on the proposed design output by the text-to-image model as an editable design template.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

The drawing figures depict one or more implementations in accord with the present teachings, by way of example only, not by way of limitation. In the figures, like reference numerals refer to the same or similar elements. Furthermore, it should be understood that the drawings are not necessarily to scale.

FIG. 1 depicts a flow chart illustrating a method according to principles described herein for generating new template assets for a template library in a scalable manner.

FIG. 2 depicts another flow chart with additional details for the method of FIG. 1.

FIG. 3 depicts another flow chart with additional details for the method of FIG. 2.

FIG. 4 depicts a system, including an artificial intelligence (AI) pipeline for generating new template assets for a template library in a scalable manner according to principles described herein.

FIG. 5 further depicts the system of FIG. 4 with an element showing the operation or workflow of the components according to principles described herein.

FIG. 6 depicts the workflow of the system of FIG. 4 according to principles described herein.

FIG. 7 is a block diagram illustrating an example software architecture, various portions of which may be used in conjunction with various hardware architectures herein described.

FIG. 8 is a block diagram illustrating components of an example machine configured to read instructions from a machine-readable medium and perform any of the features described herein.

### DETAILED DESCRIPTION

Generally, design applications have attempted to offer comprehensive design recommendations throughout the design creation process. In a simple example, a design application may commence this process with a template pane in the application that allows users to access designs from a library of design templates. More recently, such design applications have evolved to integrate user prompt-based design searching of the template library.

However, as noted above, the ability of the design suggestion features of a design application to satisfy the preferences of a user is limited by the number of available templates from which to generate recommendations. The more templates, particularly distinct templates, available, the more likely it is that the recommendation tool can present a design that fully satisfies the user. For example, assuming a library has on the order of 20,000 templates, when contrasted with the diverse array of user intents, this number of available templates remains inadequate. Thus, a technical problem in this field is the limited size of a template library from which to present proposed designs to the user.

The creation of design templates has historically relied on a labor-intensive manual process in which proficient human designers generate designs in response to specific topics or demands. Consequently, as the use and need for design applications continues to expand, scalability emerges as a significant challenge due to the need for significantly expanded template libraries and the limitations of the traditional approach in which human designers are used to produce new template assets. As a result, there is a pressing demand for a more intelligent, automated, and scalable solution to address this issue.

To solve this technical problem, this disclosure describes a technical solution involving harnessing the capabilities of Large Language Models (LLMs) and text-to-image models, such as diffusion models, in an Artificial General Intelligence (AGI) pipeline. This pipeline generates diffusion design templates, thereby significantly enhancing the scale and comprehensiveness of a template library.

An LLM is a type of Artificial Intelligence (AI) system designed to understand and generate human language. These models are built upon deep learning techniques and massive amounts of text data to process and generate natural language text. A Generative Pre-trained Transformer (GPT) is a prominent example of an LLM. GPT is trained on an extensive corpus of text from the internet and other sources, enabling it to perform a wide range of natural language processing tasks. It can understand and generate human-like text, making it highly versatile. The GPT architecture, the Transformer, is particularly adept at capturing contextual information, allowing it to produce coherent and contextually relevant responses in a wide variety of applications, from chatbots and language translation to content generation and more.

A text-to-image model is an artificial intelligence system that takes textual descriptions as input and generates corresponding images as output. One noteworthy example of such a model is the diffusion model. The diffusion model operates by iteratively improving a random noise image to align it with the given text description. It utilizes a series of diffusion steps, where noise is added and progressively removed to refine the image. This process allows the model to capture intricate details and nuances specified in the text, gradually transforming a random image into a coherent representation of the described scene. The diffusion model excels at producing high-quality, realistic images based on text prompts and has found applications in various domains, including art generation, design, and visual content creation. Its ability to bridge the gap between language and visual content holds great potential for enhancing the creative and practical aspects of AI-driven image generation.

In summary, the method described herein to generate new design templates includes three areas. (1) The generation of diverse and extensive synthetic topics in a broad spectrum that reflects topics for which users will want design templates and recommendations. As explained herein, these topics are used with generative AI to produce possible design templates. (2) The transformation of designs produced by a text-to-image model into practical and editable design assets. (3) Ensuring control and quality of the AI-generated designs, specifically, maintaining precise control over and upholding the quality of the designs generated through the process to align with product standards.

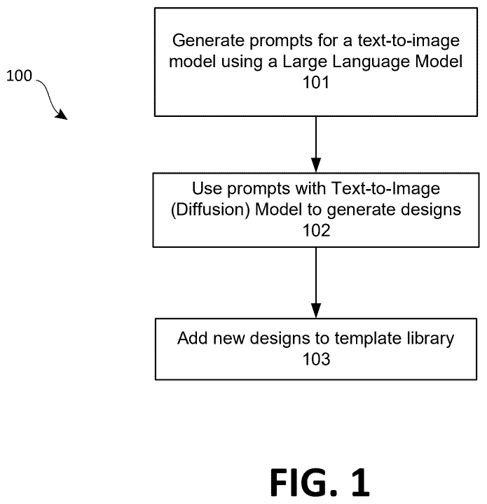

FIG. 1 depicts a flow chart illustrating a method according to principles described herein for generating new template assets for a template library in a scalable manner. As shown in FIG. 1, the method 100 first involves generating prompts for a text-to-image model using an LLM 101. For example, developers working to expand a design template library can write a list of design purposes or design categories for which design templates might be wanted. This might include groups of possible designs within different topics. For example, the list of design purposes might include:
a. Business announcements
   i. Announcing a job opening
   ii. Announcing a promotion
   iii. Announcing a new product line
   iv. . . .
b. Event announcements
   i. Announcing a birthday party
   ii. Announcing a holiday party
   iii. . . .
      Any design purpose can be included in the list of design purposes.

This list of design purposes is then used as follows. An LLM is instructed in a Natural Language prompt to generate a textual prompt for a text-to-image model instructing the text-to-image model to produce a graphic design or multiple graphic designs for each of the design purposes. As noted above, the LLM may be a GPT model.

The prompt to the LLM can include additional details of the design or can leave some or all of these details to the discretion of the LLM. For example, a prompt may specify to generate a design announcing a job opening with a particular theme, color palette or other details. Alternatively, any such details can be left unspecified or open-ended for the LLM to determine according to its training. A separate prompt may be generated for each different design purpose or a prompt may request the LLM to produce textual prompts for a text-to-image model for each of multiple included design purposes. In either case, the LLM responds with a number of text-to-image prompts written for a text-to-image model.

Next, these prompts from the LLM are submitted to the text-to-image model to generate possible designs 102. The text-to-image model may be a diffusion model, for example, DALL-E 3 or Stable Diffusion (e.g., SDXL). The text-to-image model will generate a proposed design or designs in response to the prompts from the LLM. As will be described in further detail below, these designs may be subjected to additional processing to, for example, correct spelling or grammar errors, provide for editability and ensure quality. Then, the designs can be added to a template library 103 for use by a design application. In this way, the technical problem described above of lacking a sufficiently large template library is solved. Rather than requiring human designers to produce new design template assets for the library, the approach described here provides a technical solution in which multiple generative AI models are used in a pipeline to build the design template library without the previous limitations.

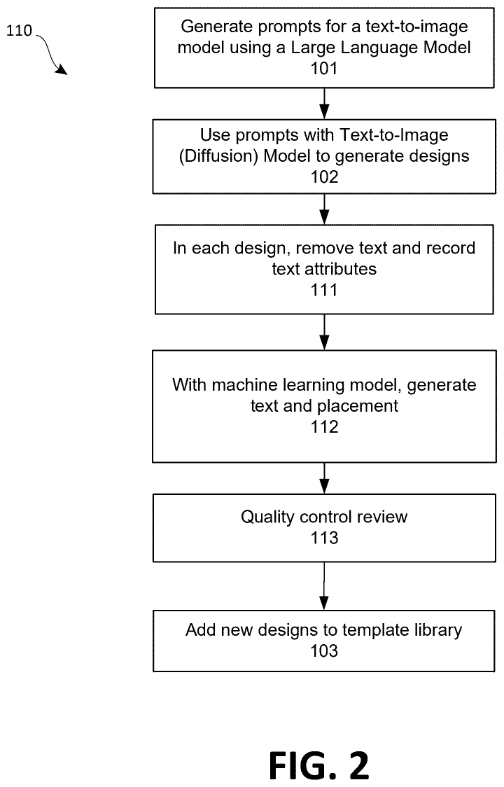

FIG. 2 depicts another flow chart with additional details for the method of FIG. 1. As noted above, the designs produced by the text-to-image model will likely need additional processing to maximize their utility to a user and to ensure design quality. Consequently, FIG. 2 illustrates some of that additional processing which can be incorporated into this pipeline.

For example, the designs produced by the text-to-image model will very often include text along with a background image or graphic elements. However, it is a known issue with text-to-image models, that the text in designs produced is prone to misspellings and other grammatical errors. Consequently, as shown in FIG. 2, after the text-to-image model generates designs based on the prompts from the LLM 102, the method moves to removing any text from each of the designs 111. In doing so, the method keeps a record of the attributes of the text including, for example, placement in the design, font, color, size, content, etc. 111.

After the text is removed from the design 111, an additional Machine Learning (ML) model can ingest the attributes of the removed text and generate a text box to be added back to the design. As will be described in more detail below, this ML model can be trained on a training set that includes a large number of aesthetically pleasing designs that include text on a background image or with graphic elements. From this training, the ML model learns how to add text to a graphic design in an aesthetically effective way. This ML model can also correct any typographical errors, misspellings or grammatical errors in the text that was generated by the text-to-image model. Thus, with this ML model, the method generates text and placement of that text 112. This generated text is then added back to the design from the text-to-image model and from which all text was previously removed 111.

The resulting design can then be subject to quality control review 113 before potentially being added to the template library 103. The quality control review 113 can involve several different techniques or a combination of any of them. Most simply, a human reviewer can approve or disapprove of designs produced by the pipeline described above. Additionally, crowdsourcing, for example using a Universal Human Relevance System (UHRS), could be used to vet the designs coming out of the pipeline. In such an approach, the designs are reviewed by a number of reviewers on a crowdsourcing platform. Designs that achieve a score by reviewers above a threshold can be added to the design template library 103. In still another approach, a multimodal AI model that operates on both images and text can be trained to evaluate the designs and determine which will be added to the template library 103. In this approach, the multimodal AI model can be trained using a library of designs of an assured quality level and/or with data from the crowdsourcing system that approves or disapproves of designs.

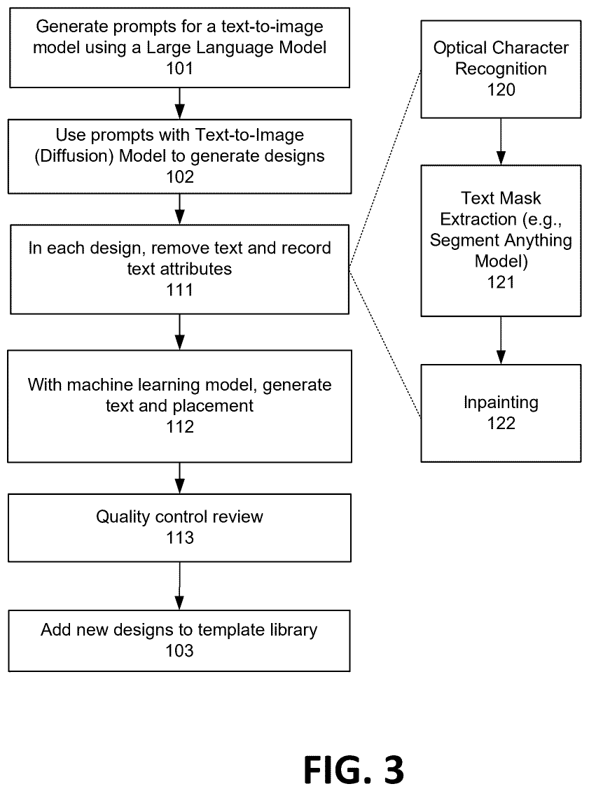

FIG. 3 depicts another flow chart with additional details for the method of FIG. 2. In particular, FIG. 3 illustrates how the removal of text is performed from the designs output by the text-to-image model 102. As shown in FIG. 3, an optical recognition (OCR) tool 120 is used on the designs from the text-to-image model. If those designs include text, the OCR tool will identify that text and attempt to render the text in editable characters.

Next, a text mask containing the text is identified and extracted from the design 121. This is done by identifying the text found by the OCR tool as an object in the design. Then, a Segment Anything Model (SAM) is used to segment the text mask from the background image or other graphic elements.

A Segment Anything Model is a type of machine learning model designed to segment or separate different objects or elements within an input data stream, typically in the context of computer vision tasks, within an image or graphic design. The primary goal of this model is to identify and delineate distinct regions or segments within an image or video, such as identifying and outlining individual objects, people, or specific areas of interest.

The SAM operates essentially as a sophisticated pattern recognition system. The SAM takes an input image or video frame and processes it through a neural network architecture, often based on deep learning techniques. The model's initial layers extract low-level features like edges, colors, and textures, gradually moving to higher-level features that represent more complex shapes and patterns. As the input data passes through the network, the model learns to recognize and differentiate between various objects or elements based on these features. It does this by adjusting the weights and biases of its neurons during training, optimizing its ability to make accurate segmentations. Thus, a SAM is useful for its ability to adapt and generalize across different types of objects and scenes. Unlike traditional computer vision methods that may require handcrafted rules or templates for specific tasks, SAMs can learn to segment a wide range of objects and scenes from diverse data sources. This adaptability is achieved through extensive training on large datasets, allowing the model to discover meaningful patterns and relationships on its own. Once trained, the Segment Anything Model can be applied to new images or video frames to automatically segment the objects or elements of interest. This segmentation can have various applications, such as object recognition, image editing, autonomous driving, and more, where the ability to separate and understand different components within visual data is crucial.

Again, in the present system, the SAM is used to identify the text mask based on the output of the OCR tool. The text mask comprises the pixels in the image that constitute the text. Once the text mask is identified, it is removed from the design image 121.

Lastly, the design from which the text mask was extracted is input to an inpainting tool to fill in the pixels of the extracted text mask. Inpainting is a computer vision and image processing technique used to fill in or replace missing or damaged parts of an image with plausible content, making the imperfections visually seamless and coherent within the context of the surrounding image. This process is often used for tasks like restoring old or damaged photographs, removing unwanted objects or blemishes, and completing images where certain areas are obscured or missing.

The underlying principle of inpainting is to use the information available in the surrounding regions of the missing or damaged area to estimate and generate the missing content. It typically involves two main steps: feature extraction and content generation. In feature extraction, the tool or algorithm analyzes the image to understand its structure, texture, and color patterns. The tool identifies relevant features and patterns in the vicinity of the missing area, in this case, where the text mask was extracted. The features and patterns identified include edges, textures, and gradients, which are crucial for maintaining the visual consistency of the inpainted region. Once the relevant features are extracted, the inpainting tool performs content generation for the missing content by predicting what should be present in the damaged or missing region based on the information from nearby areas. This prediction can be done using various techniques, including texture synthesis, patch-based methods, or deep learning approaches like convolutional neural networks (CNNs). For instance, in deep learning-based inpainting methods, a trained neural network is used to generate the missing content. The network learns to understand the context and relationships between different parts of the image during training, enabling it to generate realistic replacements for the damaged or missing regions. The network's architecture and loss functions are designed to encourage smooth transitions and consistency between the inpainted area and the surrounding regions.

Once inpainting 122 is completed, the result is the design from the text-to-image model without any text. As noted above, the text directly from the text-to-image model often includes typographical or other errors. With that original text removed, the ML model described above regenerates the text, without the errors, and with aesthetic adjustment of the original text attributes to restore appropriate textual content to the design 112. As described above, the design is then subject to quality control review 113 and, potentially, added to the template library 103.

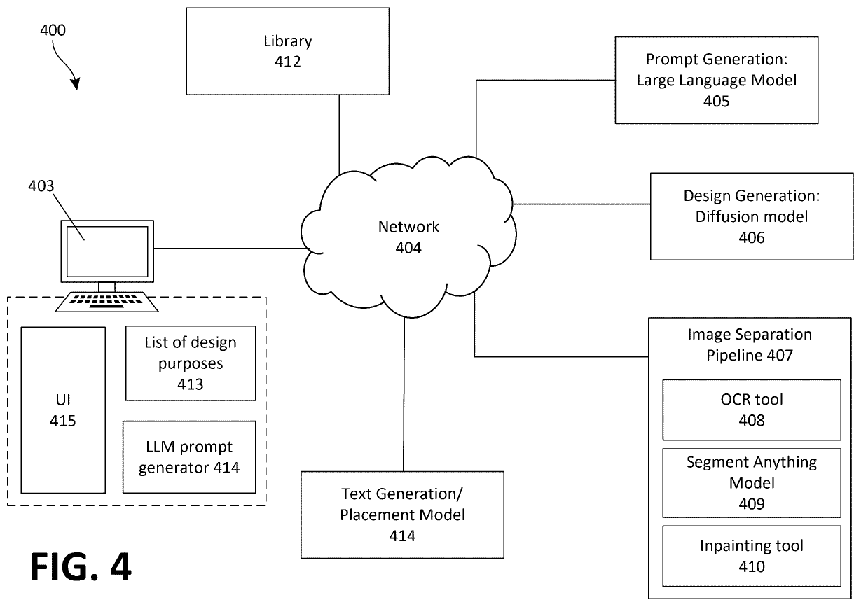

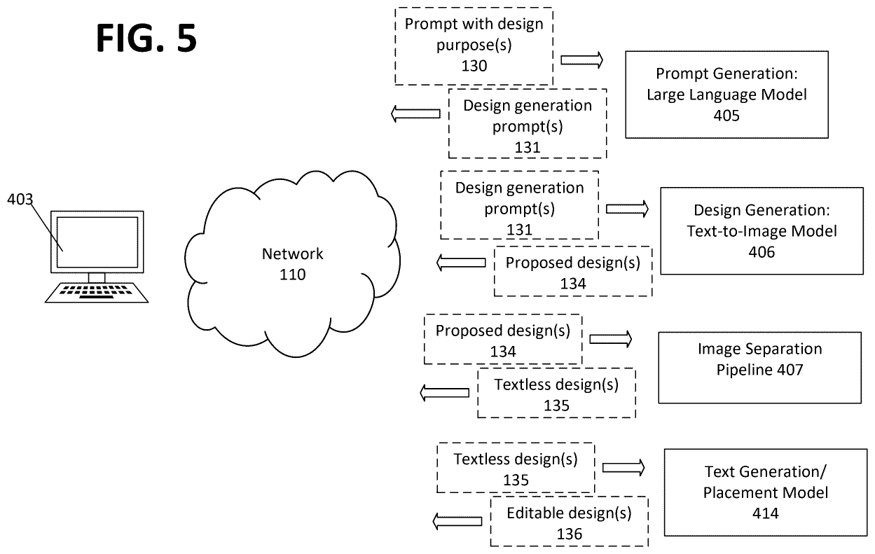

FIGS. 4 and 5 depict a system, including an AI pipeline, for generating new template assets for a template library in a scalable manner according to principles described herein. Referring to both FIGS. 4 and 5, the system 400 may include a user terminal 403 that is used by a developer whose goal is to add additional design templates to the template library 412. As described above, the template library 412 is used by design applications or design suggestion features of various productivity applications to recommend designs to a user based either on design elements the user has already added to a canvas or a textual query by the user for the type of design to be created.

A User Interface (UI) 415 of the user terminal 403 provides controls for the developer to operate all the components of the system or pipeline as described herein. A network 404 may be the medium by which the user terminal 403 communicates with each of the components of the pipeline, as shown in FIG. 4.

The developer using the terminal 403 will compile a list of design purposes 413, as described above. This list 413 can be assembled by monitoring user queries to the design application, sending a prompt to an LLM or from the developer's own knowledge and experience. Once the list of design purposes 413 is assembled, an LLM prompt generator 414 of the terminal 403 is used to generate a prompt 130 for an LLM 405. In other examples, the prompt generator may be in the clous and provided as a service to the user. These prompts are carefully curated to exhibit qualities such as descriptiveness, intricacy, and a rich diversity in terms of style, intentions, and color schemes. The prompts are meticulously designed to serve as the input for the subsequent text-to-image generation facilitated by the diffusion models. Thus, as described above, this prompt 130 will instruct the LLM 405 to draft a number of prompts specifically for a text-to-image model 406 to produce a design based on or corresponding to each purpose in the list of design purposes 413. This prompt will typically be in Natural Language for input to the LLM 405.

The LLM 405 will ingest this prompt or prompts 130 and will return corresponding design generation prompts 131 for input to a text-to-image model 406. The LLM 405 may be finetuned to generate prompts that will be effective at soliciting quality images from the text-to-image model 406. As shown in FIG. 5, the design generation prompts 131 from the LLM 405 are submitted to the text-to-image model 406. The text-to-image model 406 will then return corresponding proposed designs 134 based on the prompts from the LLM 405.

As noted above, these designs will frequently include text, which may include typographical or other errors. Consequently, the proposed designs 134 are input to an image separation pipeline 407. As shown in FIG. 4 and described above, this pipeline 407 may include an OCR tool 408, a Segment Anything Model 409 and an inpainting tool 410. Accordingly, the image separation pipeline 407 removes text from the proposed designs 134 and outputs corresponding textless designs 135.

Lastly, the textless designs 135 are input to the text generation and placement model 414, as described above. The text generation and placement model 414 will reintroduce appropriate and corrected text to the textless designs 135. The text is added as a text box that is fully editable to the end user. The result is a number of editable designs 136 that are returned to the developer at user terminal 403. As described above, the editable designs 136 can be subjected to quality review and may, eventually, be added to the template library as new design assets.

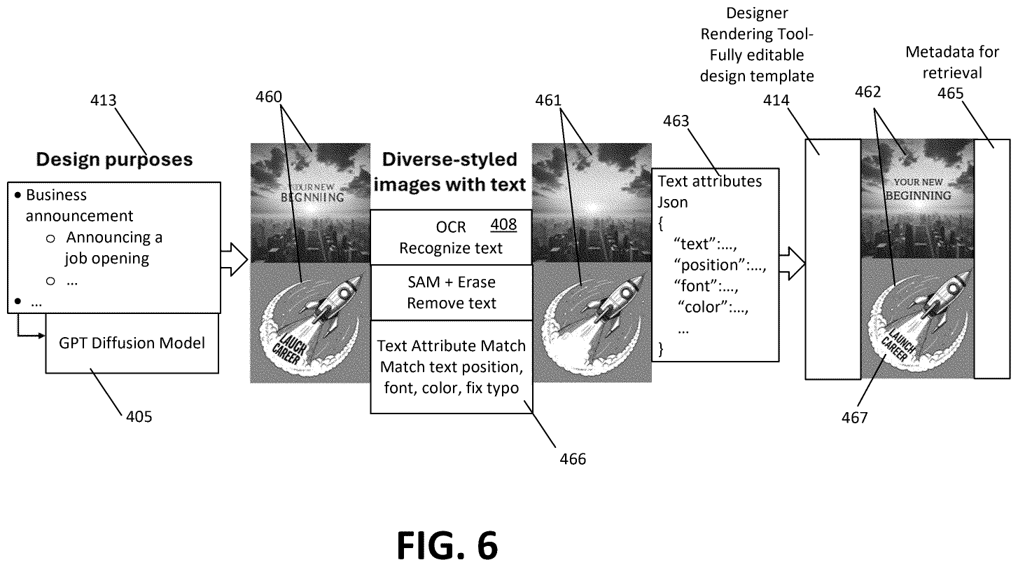

FIG. 6 depicts the workflow of the system of FIG. 4 according to principles described herein. As shown in FIG. 6, the workflow begins with the list of design purposes 413, as described above. These are used as the basis for prompts to the LLM or GPT 405, as described above. This results in prompts for the text-to-image model which produces proposed designs. FIG. 6 illustrates two examples 460 of proposed designs that could be output by the text-to-image model. As shown in FIG. 6, these designs include text which suffers from typographical or other errors.

These proposed designs 460 are then processed as described above. As shown in FIG. 6, this includes processing with an OCR tool 408 to identify and recognize text. Then, a Segment Anything Model (SAM) 409 is used to erase the text from the proposed designs. This will include inpainting, as described above. Text attributes 466 are noted for the text that is removed or erased from the images. The result is shown at 461 where corresponding textless designs are produced. The text attributes, for example, in a JSON format, 463 are communicated with the textless designs to a design rendering tool 414.

As described, the design rendering tool or text generation/placement model 414 adds appropriate or corrected text back to the textless designs. These resulting designs are shown at 462. As noted above, the text added to these designs is in a text box 467 making the design fully editable to the end user. Metadata 465 is also generated to be associated with the designs to facilitate their retrieval based on a user query. For example, the metadata in FIG. 6 might detail that the designs related to announcing a job opening as a business announcement. Consequently, any user query in this area can be matched to the corresponding designs using the design metadata 465.

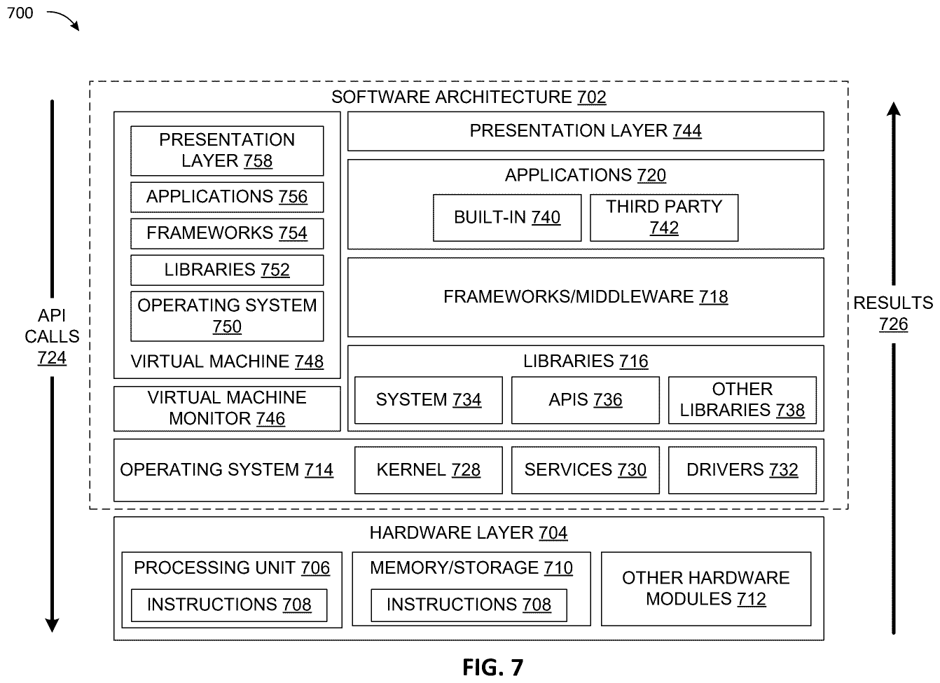

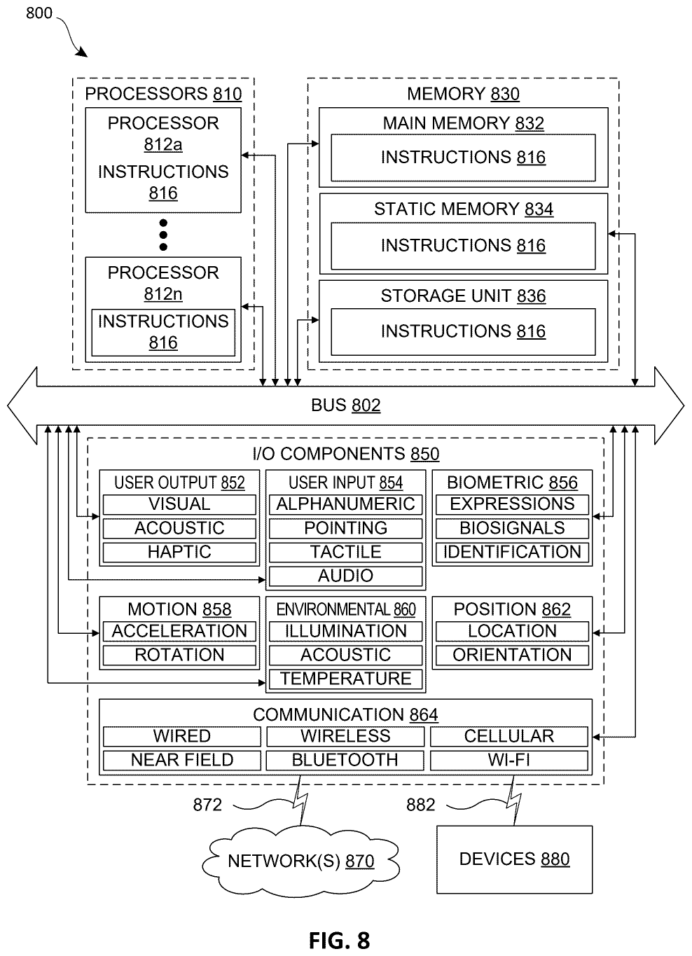

FIG. 7 is a block diagram 700 illustrating an example software architecture 702, various portions of which may be used in conjunction with various hardware architectures herein described, which may implement any of the above-described features. FIG. 7 is a non-limiting example of a software architecture, and it will be appreciated that many other architectures may be implemented to facilitate the functionality described herein. The software architecture 702 may execute on hardware such as a machine 800 of FIG. 8 that includes, among other things, processors 810, memory 830, and input/output (I/O) components 850. A representative hardware layer 704 is illustrated and can represent, for example, the machine 800 of FIG. 8. The representative hardware layer 704 includes a processing unit 706 and associated executable instructions 708. The executable instructions 708 represent executable instructions of the software architecture 702, including implementation of the methods, modules and so forth described herein. The hardware layer 704 also includes a memory/storage 710, which also includes the executable instructions 708 and accompanying data. The hardware layer 704 may also include other hardware modules 712. Instructions 708 held by processing unit 706 may be portions of instructions 708 held by the memory/storage 710.

The example software architecture 702 may be conceptualized as layers, each providing various functionality. For example, the software architecture 702 may include layers and components such as an operating system (OS) 714, libraries 716, frameworks 718, applications 720, and a presentation layer 744. Operationally, the applications 720 and/or other components within the layers may invoke API calls 724 to other layers and receive corresponding results 726. The layers illustrated are representative in nature and other software architectures may include additional or different layers. For example, some mobile or special purpose operating systems may not provide the frameworks/middleware 718.

The OS 714 may manage hardware resources and provide common services. The OS 714 may include, for example, a kernel 728, services 730, and drivers 732. The kernel 728 may act as an abstraction layer between the hardware layer 704 and other software layers. For example, the kernel 728 may be responsible for memory management, processor management (for example, scheduling), component management, networking, security settings, and so on. The services 730 may provide other common services for the other software layers. The drivers 732 may be responsible for controlling or interfacing with the underlying hardware layer 704. For instance, the drivers 732 may include display drivers, camera drivers, memory/storage drivers, peripheral device drivers (for example, via Universal Serial Bus (USB)), network and/or wireless communication drivers, audio drivers, and so forth depending on the hardware and/or software configuration.

The libraries 716 may provide a common infrastructure that may be used by the applications 720 and/or other components and/or layers. The libraries 716 typically provide functionality for use by other software modules to perform tasks, rather than rather than interacting directly with the OS 714. The libraries 716 may include system libraries 734 (for example, C standard library) that may provide functions such as memory allocation, string manipulation, file operations. In addition, the libraries 716 may include API libraries 736 such as media libraries (for example, supporting presentation and manipulation of image, sound, and/or video data formats), graphics libraries (for example, an OpenGL library for rendering 2D and 3D graphics on a display), database libraries (for example, SQLite or other relational database functions), and web libraries (for example, WebKit that may provide web browsing functionality). The libraries 716 may also include a wide variety of other libraries 738 to provide many functions for applications 720 and other software modules.

The frameworks 718 (also sometimes referred to as middleware) provide a higher-level common infrastructure that may be used by the applications 720 and/or other software modules. For example, the frameworks 718 may provide various graphic user interface (GUI) functions, high-level resource management, or high-level location services. The frameworks 718 may provide a broad spectrum of other APIs for applications 720 and/or other software modules.

The applications 720 include built-in applications 740 and/or third-party applications 742. Examples of built-in applications 740 may include, but are not limited to, a contacts application, a browser application, a location application, a media application, a messaging application, and/or a game application. Third-party applications 742 may include any applications developed by an entity other than the vendor of the particular platform. The applications 720 may use functions available via OS 714, libraries 716, frameworks 718, and presentation layer 744 to create user interfaces to interact with users.

Some software architectures use virtual machines, as illustrated by a virtual machine 748. The virtual machine 748 provides an execution environment where applications/modules can execute as if they were executing on a hardware machine (such as the machine 800 of FIG. 8, for example). The virtual machine 748 may be hosted by a host OS (for example, OS 714) or hypervisor, and may have a virtual machine monitor 746 which manages operation of the virtual machine 748 and interoperation with the host operating system. A software architecture, which may be different from software architecture 702 outside of the virtual machine, executes within the virtual machine 748 such as an OS 750, libraries 752, frameworks 754, applications 756, and/or a presentation layer 758.

FIG. 8 is a block diagram illustrating components of an example machine 800 configured to read instructions from a machine-readable medium (for example, a machine-readable storage medium) and perform any of the features described herein. The example machine 800 is in a form of a computer system, within which instructions 816 (for example, in the form of software components) for causing the machine 800 to perform any of the features described herein may be executed.

As such, the instructions 816 may be used to implement modules or components described herein. The instructions 816 cause unprogrammed and/or unconfigured machine 800 to operate as a particular machine configured to carry out the described features. The machine 800 may be configured to operate as a standalone device or may be coupled (for example, networked) to other machines. In a networked deployment, the machine 800 may operate in the capacity of a server machine or a client machine in a server-client network environment, or as a node in a peer-to-peer or distributed network environment. Machine 800 may be embodied as, for example, a server computer, a client computer, a personal computer (PC), a tablet computer, a laptop computer, a netbook, a set-top box (STB), a gaming and/or entertainment system, a smart phone, a mobile device, a wearable device (for example, a smart watch), and an Internet of Things (IoT) device. Further, although only a single machine 800 is illustrated, the term “machine” includes a collection of machines that individually or jointly execute the instructions 816.

The machine 800 may include processors 810, memory 830, and I/O components 850, which may be communicatively coupled via, for example, a bus 802. The bus 802 may include multiple buses coupling various elements of machine 800 via various bus technologies and protocols. In an example, the processors 810 (including, for example, a central processing unit (CPU), a graphics processing unit (GPU), a digital signal processor (DSP), an ASIC, or a suitable combination thereof) may include one or more processors 812a to 812n that may execute the instructions 816 and process data. In some examples, one or more processors 810 may execute instructions provided or identified by one or more other processors 810. The term “processor” includes a multi-core processor including cores that may execute instructions contemporaneously. Although FIG. 8 shows multiple processors, the machine 800 may include a single processor with a single core, a single processor with multiple cores (for example, a multi-core processor), multiple processors each with a single core, multiple processors each with multiple cores, or any combination thereof. In some examples, the machine 800 may include multiple processors distributed among multiple machines.

The memory/storage 830 may include a main memory 832, a static memory 834, or other memory, and a storage unit 836, both accessible to the processors 810 such as via the bus 802. The storage unit 836 and memory 832, 834 store instructions 816 embodying any one or more of the functions described herein. The memory/storage 830 may also store temporary, intermediate, and/or long-term data for processors 810. The instructions 816 may also reside, completely or partially, within the memory 832, 834, within the storage unit 836, within at least one of the processors 810 (for example, within a command buffer or cache memory), within memory at least one of I/O components 850, or any suitable combination thereof, during execution thereof. Accordingly, the memory 832, 834, the storage unit 836, memory in processors 810, and memory in I/O components 850 are examples of machine-readable media.

As used herein, “machine-readable medium” refers to a device able to temporarily or permanently store instructions and data that cause machine 800 to operate in a specific fashion, and may include, but is not limited to, random-access memory (RAM), read-only memory (ROM), buffer memory, flash memory, optical storage media, magnetic storage media and devices, cache memory, network-accessible or cloud storage, other types of storage and/or any suitable combination thereof. The term “machine-readable medium” applies to a single medium, or combination of multiple media, used to store instructions (for example, instructions 816) for execution by a machine 800 such that the instructions, when executed by one or more processors 810 of the machine 800, cause the machine 800 to perform and one or more of the features described herein. Accordingly, a “machine-readable medium” may refer to a single storage device, as well as “cloud-based” storage systems or storage networks that include multiple storage apparatus or devices. The term “machine-readable medium” excludes signals per se.

The I/O components 850 may include a wide variety of hardware components adapted to receive input, provide output, produce output, transmit information, exchange information, capture measurements, and so on. The specific I/O components 850 included in a particular machine will depend on the type and/or function of the machine. For example, mobile devices such as mobile phones may include a touch input device, whereas a headless server or IoT device may not include such a touch input device. The particular examples of I/O components illustrated in FIG. 8 are in no way limiting, and other types of components may be included in machine 800. The grouping of I/O components 850 are merely for simplifying this discussion, and the grouping is in no way limiting. In various examples, the I/O components 850 may include user output components 852 and user input components 854. User output components 852 may include, for example, display components for displaying information (for example, a liquid crystal display (LCD) or a projector), acoustic components (for example, speakers), haptic components (for example, a vibratory motor or force-feedback device), and/or other signal generators. User input components 854 may include, for example, alphanumeric input components (for example, a keyboard or a touch screen), pointing components (for example, a mouse device, a touchpad, or another pointing instrument), and/or tactile input components (for example, a physical button or a touch screen that provides location and/or force of touches or touch gestures) configured for receiving various user inputs, such as user commands and/or selections.

In some examples, the I/O components 850 may include biometric components 856, motion components 858, environmental components 860, and/or position components 862, among a wide array of other physical sensor components. The biometric components 856 may include, for example, components to detect body expressions (for example, facial expressions, vocal expressions, hand or body gestures, or eye tracking), measure biosignals (for example, heart rate or brain waves), and identify a person (for example, via voice-, retina-, fingerprint-, and/or facial-based identification). The motion components 858 may include, for example, acceleration sensors (for example, an accelerometer) and rotation sensors (for example, a gyroscope). The environmental components 860 may include, for example, illumination sensors, temperature sensors, humidity sensors, pressure sensors (for example, a barometer), acoustic sensors (for example, a microphone used to detect ambient noise), proximity sensors (for example, infrared sensing of nearby objects), and/or other components that may provide indications, measurements, or signals corresponding to a surrounding physical environment. The position components 862 may include, for example, location sensors (for example, a Global Position System (GPS) receiver), altitude sensors (for example, an air pressure sensor from which altitude may be derived), and/or orientation sensors (for example, magnetometers).

The I/O components 850 may include communication components 864, implementing a wide variety of technologies operable to couple the machine 800 to network(s) 870 and/or device(s) 880 via respective communicative couplings 872 and 882. The communication components 864 may include one or more network interface components or other suitable devices to interface with the network(s) 870. The communication components 864 may include, for example, components adapted to provide wired communication, wireless communication, cellular communication, Near Field Communication (NFC), Bluetooth communication, Wi-Fi, and/or communication via other modalities. The device(s) 880 may include other machines or various peripheral devices (for example, coupled via USB).

In some examples, the communication components 864 may detect identifiers or include components adapted to detect identifiers. For example, the communication components 864 may include Radio Frequency Identification (RFID) tag readers, NFC detectors, optical sensors (for example, one-or multi-dimensional bar codes, or other optical codes), and/or acoustic detectors (for example, microphones to identify tagged audio signals). In some examples, location information may be determined based on information from the communication components 864, such as, but not limited to, geo-location via Internet Protocol (IP) address, location via Wi-Fi, cellular, NFC, Bluetooth, or other wireless station identification and/or signal triangulation.

While various embodiments have been described, the description is intended to be exemplary, rather than limiting, and it is understood that many more embodiments and implementations are possible that are within the scope of the embodiments. Although many possible combinations of features are shown in the accompanying figures and discussed in this detailed description, many other combinations of the disclosed features are possible. Any feature of any embodiment may be used in combination with or substituted for any other feature or element in any other embodiment unless specifically restricted. Therefore, it will be understood that any of the features shown and/or discussed in the present disclosure may be implemented together in any suitable combination. Accordingly, the embodiments are not to be restricted except in light of the attached claims and their equivalents. Also, various modifications and changes may be made within the scope of the attached claims.

Generally, functions described herein (for example, the features illustrated in FIGS. 1-6) can be implemented using software, firmware, hardware (for example, fixed logic, finite state machines, and/or other circuits), or a combination of these implementations. In the case of a software implementation, program code performs specified tasks when executed on a processor (for example, a CPU or CPUs). The program code can be stored in one or more machine-readable memory devices. The features of the techniques described herein are system-independent, meaning that the techniques may be implemented on a variety of computing systems having a variety of processors. For example, implementations may include an entity (for example, software) that causes hardware to perform operations, e.g., processors functional blocks, and so on. For example, a hardware device may include a machine-readable medium that may be configured to maintain instructions that cause the hardware device, including an operating system executed thereon and associated hardware, to perform operations. Thus, the instructions may function to configure an operating system and associated hardware to perform the operations and thereby configure or otherwise adapt a hardware device to perform functions described above. The instructions may be provided by the machine-readable medium through a variety of different configurations to hardware elements that execute the instructions.

In the following, further features, characteristics and advantages of the invention will be described by means of items:

Item 1. A data processing system comprising:
a processor, and
a memory storing executable instructions which, when executed by the processor, cause the processor alone or in combination with other processors to perform the following functions:
based on a list of design purposes, generate prompts requesting a Large Language Model (LLM) to produce corresponding prompts for input to a text-to-image model to generate a proposed design corresponding to each design purpose;
submit the prompts from the LLM to the text-to-image model;
receive the proposed designs from the text-to-image model; and increase a design template library by adding a design based on the proposed designs output by the text-to-image model.

Item 2. The system of Item 1, wherein the text-to-image model is a diffusion model.

Item 3. The system of Item 1, wherein the LLM is a Generative Pretrained Transformer (GPT) model.

Item 4. The system of Item 1, wherein the instructions further cause the processor to remove text generated by the text-to-image model in the proposed design.

Item 5. The system of Item 4, wherein removing the text generated by the text-to-image model comprises:
using an Optical Character Recognition (OCR) tool to identify the text in the proposed design;
using a Segment Anything Model (SAM) to identify a text mask for the text used to remove the text; and
using an inpainting tool to fill in the proposed design where the text was removed.

Item 6. The system of Item 4, wherein the instructions further cause the processor to use a text generation/placement model to add text back to the proposed design.

Item 7. The system of Item 6, wherein the text generation/placement model uses text attributes from the proposed design as output by the text-to-image model.

Item 8. The system of Item 6, wherein the added text is in a text box that is editable.

Item 9. The system of Item 6, wherein the text generation/placement model corrects typographical or other errors from text in the proposed design as generated by the text-to-image model.

Item 10. The system of Item 1, wherein the instructions further cause the processor to associate metadata with the design added to the template library to facilitate retrieval of the design based on a user query.

Item 11. The system of Item 1, wherein the instructions further cause the processor to complete a quality control review workflow on the design before the design is added to the template library.

Item 12. A method of increasing a design template library supporting a design recommendation feature in a productivity application, the method comprising:
based on a list of design purposes, generating prompts requesting a Large Language Model (LLM) to produce corresponding prompts for a text-to-image model for the text-to-image model to generate a proposed design corresponding to each design purpose;
receiving the proposed design from the text-to-image model; and increasing a design template library by adding a design based on the proposed design output by the text-to-image model.

Item 13. The method of Item 12, wherein the text-to-image model is a diffusion model and the LLM is a Generative Pretrained Transformer (GPT) model.

Item 14. The method of Item 12, further comprising removing text generated by the text-to-image model from within the proposed design.

Item 15. The method of Item 14, wherein removing the text generated by the text-to-image model comprises:
using an Optical Character Recognition (OCR) tool to identify the text in the proposed design;
using a Segment Anything Model (SAM) to identify a text mask for the text used to remove the text; and
using an inpainting tool to fill in the proposed design where the text was removed.

Item 16. The method of Item 14, further comprising, with a text generation/placement machine learning model, adding text back to the proposed design.

Item 17. The method of Item 16, wherein the text generation/placement model uses text attributes from the proposed design as output by the text-to-image model.

Item 18. The method of Item 16, wherein the added text is in a text box that is editable.

Item 19. The method of Item 16, further comprising correcting typographical or other errors from text in the proposed design as generated by the text-to-image model.

Item 20. A method of increasing a design template library supporting a design recommendation feature in a productivity application, the method comprising:
based on a list of design purposes, generating prompts requesting a Large Language Model (LLM) to produce corresponding prompts for a text-to-image model for the text-to-image model to generate a proposed design corresponding to each design purpose;
receiving the proposed design from the text-to-image model;
removing text generated by the text-to-image model from within the proposed design by using an Optical Character Recognition (OCR) tool to identify the text in the proposed design, using a Segment Anything Model (SAM) to identify a text mask for the text used to remove the text, and using an inpainting tool to fill in the proposed design where the text was removed; and
providing a resulting design based on the proposed design output by the text-to-image model as an editable design template.

In the foregoing detailed description, numerous specific details were set forth by way of examples in order to provide a thorough understanding of the relevant teachings. It will be apparent to persons of ordinary skill, upon reading the description, that various aspects can be practiced without such details. In other instances, well known methods, procedures, components, and/or circuitry have been described at a relatively high-level, without detail, in order to avoid unnecessarily obscuring aspects of the present teachings.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows, and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein.

Relational terms such as first and second and the like may be used solely to distinguish one entity or action from another without necessarily requiring or implying any actual such relationship or order between such entities or actions. The terms “comprises,” “comprising,” and any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “a” or “an” does not, without further constraints, preclude the existence of additional identical elements in the process, method, article, or apparatus that comprises the element.

The Abstract of the Disclosure is provided to allow the reader to quickly identify the nature of the technical disclosure. It is submitted with the understanding that it will not be used to interpret or limit the scope or meaning of the claims. In addition, in the foregoing Detailed Description, it can be seen that various features are grouped together in various examples for the purpose of streamlining the disclosure. This method of disclosure is not to be interpreted as reflecting an intention that any claim requires more features than the claim expressly recites. Rather, as the following claims reflect, inventive subject matter lies in less than all features of a single disclosed example. Thus, the following claims are hereby incorporated into the Detailed Description, with each claim standing on its own as a separately claimed subject matter.

What is claimed is:

1. A data processing system comprising:
a processor, and
a memory storing executable instructions which, when executed by the processor, cause the processor alone or in combination with other processors to perform the following functions:
based on a list of design purposes, generate prompts requesting a Large Language Model (LLM) to produce corresponding prompts for input to a text-to-image model to generate a proposed design corresponding to each design purpose;
submit the prompts from the LLM to the text-to-image model;
receive the proposed designs from the text-to-image model; and
increase a design template library by adding a design based on the proposed designs output by the text-to-image model.

2. The system of claim 1, wherein the text-to-image model is a diffusion model.

3. The system of claim 1, wherein the LLM is a Generative Pretrained Transformer (GPT) model.

4. The system of claim 1, wherein the instructions further cause the processor to remove text generated by the text-to-image model in the proposed design.

5. The system of claim 4, wherein removing the text generated by the text-to-image model comprises:
using an Optical Character Recognition (OCR) tool to identify the text in the proposed design;
using a Segment Anything Model (SAM) to identify a text mask for the text used to remove the text; and
using an inpainting tool to fill in the proposed design where the text was removed.

6. The system of claim 4, wherein the instructions further cause the processor to use a text generation/placement model to add text back to the proposed design.

7. The system of claim 6, wherein the text generation/placement model uses text attributes from the proposed design as output by the text-to-image model.

8. The system of claim 6, wherein the added text is in a text box that is editable.

9. The system of claim 6, wherein the text generation/placement model corrects typographical or other errors from text in the proposed design as generated by the text-to-image model.

10. The system of claim 1, wherein the instructions further cause the processor to associate metadata with the design added to the template library to facilitate retrieval of the design based on a user query.

11. The system of claim 1, wherein the instructions further cause the processor to complete a quality control review workflow on the design before the design is added to the template library.

12. A method of increasing a design template library supporting a design recommendation feature in a productivity application, the method comprising:
based on a list of design purposes, generating prompts requesting a Large Language Model (LLM) to produce corresponding prompts for a text-to-image model for the text-to-image model to generate a proposed design corresponding to each design purpose;
receiving the proposed design from the text-to-image model; and
increasing a design template library by adding a design based on the proposed design output by the text-to-image model.

13. The method of claim 12, wherein the text-to-image model is a diffusion model and the LLM is a Generative Pretrained Transformer (GPT) model.

14. The method of claim 12, further comprising removing text generated by the text-to-image model from within the proposed design.

15. The method of claim 14, wherein removing the text generated by the text-to-image model comprises:
using an Optical Character Recognition (OCR) tool to identify the text in the proposed design;
using a Segment Anything Model (SAM) to identify a text mask for the text used to remove the text; and
using an inpainting tool to fill in the proposed design where the text was removed.

16. The method of claim 14, further comprising, with a text generation/placement machine learning model, adding text back to the proposed design.

17. The method of claim 16, wherein the text generation/placement model uses text attributes from the proposed design as output by the text-to-image model.

18. The method of claim 16, wherein the added text is in a text box that is editable.

19. The method of claim 16, further comprising correcting typographical or other errors from text in the proposed design as generated by the text-to-image model.

20. A method of increasing a design template library supporting a design recommendation feature in a productivity application, the method comprising:
based on a list of design purposes, generating prompts requesting a Large Language Model (LLM) to produce corresponding prompts for a text-to-image model for the text-to-image model to generate a proposed design corresponding to each design purpose;
receiving the proposed design from the text-to-image model;
removing text generated by the text-to-image model from within the proposed design by using an Optical Character Recognition (OCR) tool to identify the text in the proposed design, using a Segment Anything Model (SAM) to identify a text mask for the text used to remove the text, and using an inpainting tool to fill in the proposed design where the text was removed; and
providing a resulting design based on the proposed design output by the text-to-image model as an editable design template.
